(19) United States
(12) Patent Application Publication
(10) Pub. No.: US 2012/0054788 A1
(43) Pub. Date: Mar. 1, 2012

(54) ELECTRONIC EQUIPMENT

(75) Inventor: Hideaki Takenaka, Nishinomiya City (JP)

(73) Assignee: SANYO ELECTRIC CO., LTD., Moriguchi City (JP)

(21) Appl. No.: 13/212,693

(22) Filed: Aug. 18, 2011

(30) Foreign Application Priority Data
Aug. 26, 2010 (JP) 2010-189211

(51) Int. Cl. H04N 21/454

(52) U.S. Cl. 725/28

(57) ABSTRACT

Electronic equipment has Internet connection function and parental control function. The electronic equipment includes a storage portion that stores rating information about contents on the Internet, and a viewing restricting portion that performs view restriction of the contents on the Internet based on the rating information about contents on the Internet stored in the storage portion.

### CROSS-REFERENCE TO RELATED APPLICATIONS

This nonprovisional application claims priority under 35 U.S.C. §119(a) on Patent Application No. 2010-189211 filed in Japan on Aug. 26, 2010, the entire contents of which are hereby incorporated by reference.

### BACKGROUND OF THE INVENTION

1. Field of the Invention

The present invention relates to electronic equipment having Internet connection function and parental control function.

2. Description of Related Art

In order to view contents on the Internet, a personal computer (hereinafter referred to as a computer) is mainly used. When a computer is used to view contents on the Internet, a user has to install software for viewing contents on the Internet in the computer if such software is not preinstalled in the computer. In addition, the user should select and activate the software when viewing contents on the Internet. Therefore, there is a problem that it is difficult for the user who does not have enough knowledge of computer to know the method of operating and viewing.

Further, even if the user can activate the software without problem to succeed in viewing contents on the Internet, there are a lot of harmful contents or undesired contents for the user on the Internet. Therefore, view restricting software may be installed in the computer so that viewing of undesired contents or harmful contents is restricted.

In such a situation, there are developed devices that can be easily connected to the Internet by the user having little knowledge about computer so that the user can readily enjoy contents on the Internet. As one of such devices, there is a television receiver that can be connected to the Internet (an internet television set). The Internet television set has been becoming a mainstream of television receivers in recent years.

However, the conventional Internet television set is developed putting emphasis on that anyone can easily connect to the Internet so as to view contents easily. Therefore, there has been little consideration about restriction of viewing contents downloaded via the Internet. Therefore, there is a problem that the method of restricting undesired contents and harmful contents from being viewed is not established.

This problem is not limited to the Internet television set, and the problem occurs also in a set top box, an optical disc apparatus, and a hard disk recorder having the Internet connection function.

Note that there is a conventional television receiver that restricts viewing a received broadcasting program. However, this television receiver cannot restrict viewing contents on the Internet although it can restrict viewing a received broadcasting program. Therefore, even if the television receiver is used, the above-mentioned problem that there is no established means for restricting viewing of undesired contents and harmful contents cannot be solved.

### SUMMARY OF THE INVENTION

Electronic equipment according to the present invention has Internet connection function and parental control function. The electronic equipment includes a storage portion that stores rating information about contents on the Internet, and a viewing restricting portion that restricts viewing contents on the Internet based on the rating information about the contents on the Internet stored in the storage portion.

Meanings and effects of the present invention will be apparent from the following description of an embodiment of the present invention. However, the following embodiment is merely an example of the present invention. Meanings of the present invention and terms of elements are not limited to those described in the following embodiment.

### BRIEF DESCRIPTION OF THE DRAWINGS

FIG. 1 is a block diagram of a television receiver according to an embodiment of the present invention.

FIG. 2 is a flowchart illustrating an editing process of rating information about contents on the Internet that is performed by the television receiver according to the embodiment of the present invention illustrated in FIG. 1.

FIG. 3 is a flowchart illustrating an editing process of rating information about contents on the Internet that is performed by the television receiver according to the embodiment of the present invention illustrated in FIG. 1.

FIG. 4 is a diagram illustrating an example of a rating information editing screen.

FIG. 5 is a diagram illustrating another example of a rating information editing screen.

FIG. 6 is a diagram illustrating still another example of a rating information editing screen.

FIG. 7 is a diagram illustrating still another example of a rating information editing screen.

FIG. 8 is a diagram illustrating still another example of a rating information editing screen.

FIG. 9 is a diagram illustrating an example of a listing display screen of the rating information about contents on the Internet.

FIG. 10 is a diagram illustrating an example of a rating information editing screen about TV broadcasting programs.

FIG. 11 is a diagram illustrating an example of a rating information editing screen about movies.

### DETAILED DESCRIPTION OF THE PREFERRED EMBODIMENTS

An embodiment of the present invention is described below with reference to the attached drawings.

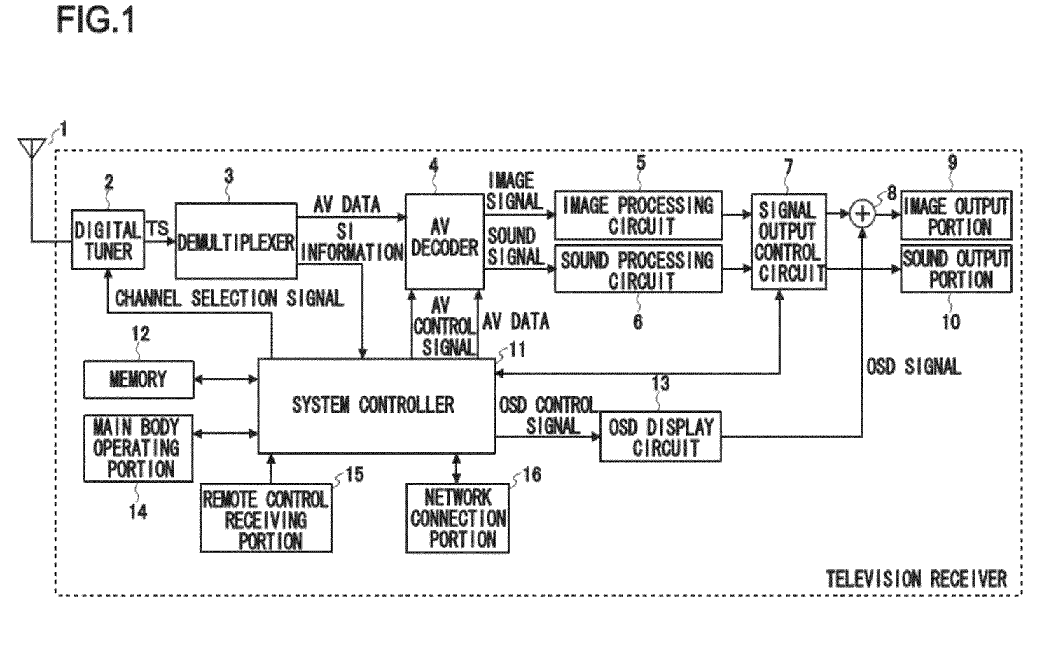

A block diagram of a television receiver according to an embodiment of the present invention is illustrated in FIG. 1. The television receiver according to the embodiment of the present invention illustrated in FIG. 1 is a television receiver having an internet connection function (internet television set), including a digital tuner 2, a demultiplexer (DEMUR) 3, an AV decoder 4, an image processing circuit 5, a sound processing circuit 6, a signal output control circuit 7, an adder 8, an image output portion 9, a sound output portion 10, a system controller 11, a memory 12, an on-screen display (OSD) circuit 13, a main body operating portion 14, a remote control receiving portion 15, and a network connection portion 16.

An antenna 1 receives a digital broadcasting wave and supplies the received signal to the digital tuner 2. The digital tuner 2 selects a physical channel by a channel selection signal from the system controller 11. The digital tuner 2 converts the received signal as a high frequency signal into a digitally modulated signal of the selected physical channel as a specific frequency signal by the channel selection process. In addition, the digital tuner 2 includes a demodulation circuit or the like that demodulates the digitally modulated signal of the selected physical channel, and outputs a transport stream TS.

The demultiplexer (DEMUR) 3 receives packets of the transport stream TS from the digital tuner 2 and decodes encrypted packets among the received packets. Then, the demultiplexer 3 separates the packets into AV data as contents of the broadcasting program and service information (SI). The AV data is supplied to the AV decoder 4, and the service information is supplied to the system controller 11.

The AV decoder 4 decodes the AV data received from the demultiplexer 3 or the system controller 11 into an image signal and a sound signal in accordance with an AV control signal output from the system controller 11. Then, the AV decoder 4 outputs the image signal to the image processing circuit 5 and outputs the sound signal to the sound processing circuit 6.

The image processing circuit 5 receives the image signal from the AV decoder 4 and performs D/A conversion on it so as to generate an analog image signal. The sound processing circuit 6 receives sound data from the AV decoder 4 or the system controller 11 so as to generate an analog sound signal by performing D/A conversion.

The system controller 11 performs various types of controls of the television receiver in accordance with an operational command output from the main body operating portion 14 that receives a key operation by a user or an operational command output from the remote control receiving portion 15 that receives a remote control infrared signal transmitted from a remote control transmitter (not shown) that receives a key operation by the user.

The memory 12 stores various programs and various data necessary for the system controller 11 to perform various controls of the television receiver in a nonvolatile manner.

The system controller 11 sends out an OSD control signal to the OSD display circuit 13 in accordance with the above-mentioned operational command or necessity of a message display.

The OSD circuit 13 generates an OSD signal based on the OSD control signal sent from the system controller 11 and outputs the OSD signal to the adder 8.

The adder 8 superimposes the OSD signal output from the OSD circuit 13 on the analog image signal output from the image processing circuit 5, and the obtained image signal as a result is supplied to the image output portion 9.

The image output portion 9 includes a display device (not shown), and an image corresponding to the image signal supplied from the adder 8 is displayed on the display screen of the display device.

The sound output portion 10 includes a speaker (not shown), and sound corresponding to the analog sound signal supplied from the sound processing circuit 6 is generated from the speaker.

The network connection portion 16 can be easily connected to the Internet via a modem (not shown) connected to the network. When the network connection portion 16 receives contents on the Internet in accordance with control of the system controller 11, the system controller 11 outputs the AV data as contents on the Internet itself received by the network connection portion 16 to the AV decoder 4.

If it is set to enable view restriction based on rating information, the signal output control circuit 7 disposed after the image processing circuit 5 and the sound processing circuit 6 performs the view restriction of the TV broadcasting program or the contents on the Internet based on the rating information stored in the memory 12. When the view restriction is performed, the output of the analog image signal from the signal output control circuit 7 to the adder 8 is stopped, and the output of the analog sound signal from the signal output control circuit 7 to the sound output portion 10 is stopped.

This embodiment uses a rating method of rating information that is used in TV Parental Guideline (so-called V-Guide) and parental information for movies (so-called MPAA Rating), which is described below.

In the Unites State, the rating information for mainly parental control of TV broadcasting programs is rated in accordance with age and content.

As to age, there are six classes of rating as follows.

TV-Y (programs for every child)

TV-Y7 (programs for children of seven years and over, who can distinguish between reality and fantasy)

TV-G (programs for general viewer, which is not specialized for children but can be viewed by children without a problem)

TV-PG (programs that may contain content inappropriate for younger children, and is desirable to be viewed with a parent)

TV-14 (programs inappropriate for children under fourteen years)

TV-MA (programs inappropriate for children under seventeen years, namely programs for adults)

As to content, there are five classes of rating as follows.

V (violence)

FV (fantastic violence)

S (any sexual description)

L (rough language)

D (provocative conversation)

On the other hand, the rating information for movie parental control is based on age, and there are six classes of rating as follows.

G (movies for general viewer)

PG (movies that may contain inappropriate content for low age children and should be viewed preferably with a parent or guardian)

PG13 (movies that are inappropriate for children under thirteen years and are recommended for children of thirteen years and over)

R (movies that should be viewed preferably with a parent or guardian for children under seventeen)

NC-17 (movies inappropriate for children under seventeen)

X (movies inappropriate for children under seventeen)

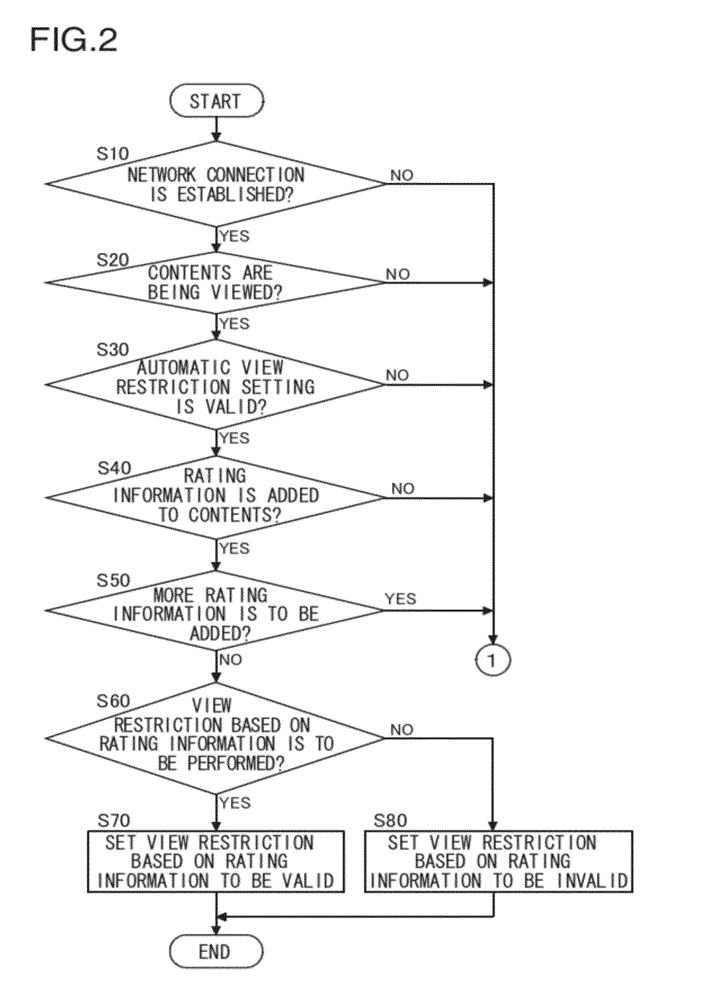

When the user instructs to edit the rating information about contents on the Internet by key operation on the main body operating portion 14 or the remote control transmitter (not shown), the flowchart action illustrated in FIG. 2 is started.

First, the system controller 11 decides whether or not the network connection portion 16 is connected to the Internet (Step S10).

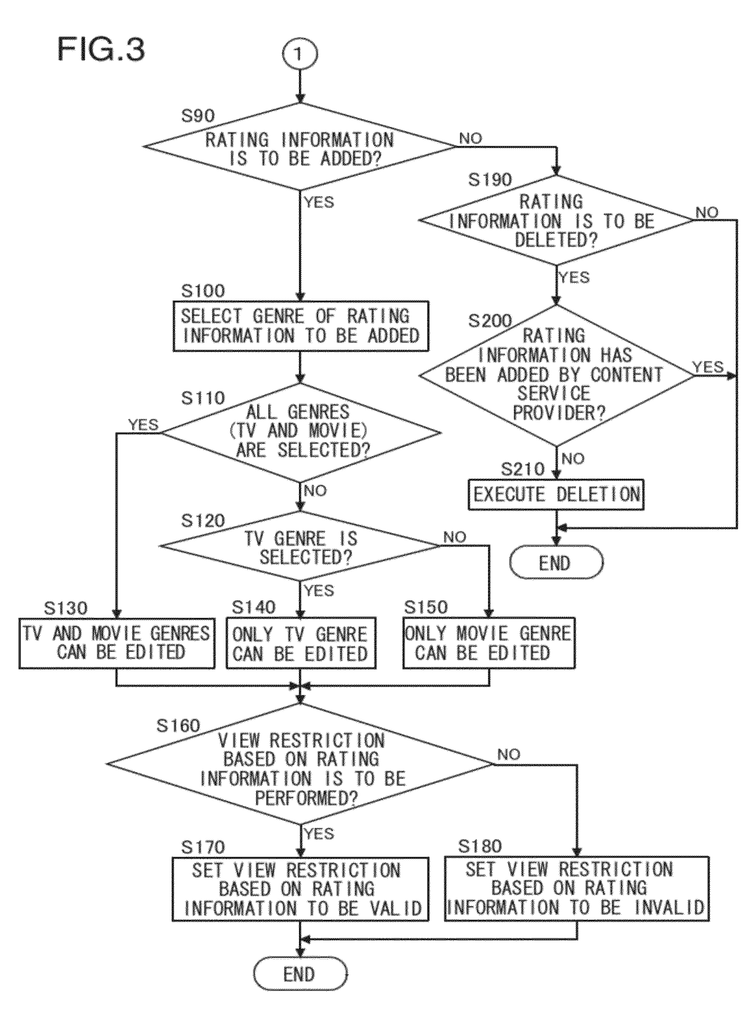

In the decision of Step S10, if it is decided that the network connection portion 16 is not connected to the Internet (NO in Step S10), the process flow goes promptly to Step S90 in the flowchart illustrated in FIG. 3 without performing the decision process of Steps S20 to S60 described later.

On the other hand, in the decision of Step S10, if it is decided that the network connection portion 16 is connected to the Internet (YES in Step S10), the system controller 11 decides whether or not the contents on the Internet is currently viewed (Step S20).

In the decision of Step S20, if it is decided that the contents on the Internet is not currently viewed (NO in Step S20), the process flow goes promptly to Step S90 of the flowchart illustrated in FIG. 3 without performing the decision process of Steps S30 to S60 described later.

On the other hand, in the decision of Step S20, if it is decided that the contents on the Internet is currently viewed (YES in Step S20), the system controller 11 decides whether a state of automatic view restriction setting stored in the memory 12 is valid or invalid (Step S30).

In the decision of Step S30, if it is decided that the automatic view restriction setting is invalid (NO in Step S30), the process flow goes promptly to Step S90 of the flowchart illustrated in FIG. 3 without performing the decision process of Steps S40 to S60 described later.

On the other hand, in the decision of Step S30, if it is decided that the automatic view restriction setting is valid (YES in Step S30), the system controller 11 decides whether or not the contents on the Internet that are currently viewed contain the rating information added by a content service provider based on the SI information (Step S40).

In the decision of Step S40, if it is decided that the contents on the Internet that are currently viewed do not contain the rating information added by the content service provider (NO in Step S40), the process flow goes promptly to Step S90 of the flowchart illustrated in FIG. 3 without performing the decision process of Steps S50 to S60 described later.

On the other hand, in the decision of Step S40, if it is decided that the contents on the Internet that are currently viewed contain the rating information added by the content service provider (YES in Step S40), the display device of the image output portion 9 displays a screen for inquiring the user whether or not to add more rating information to the contents on the Internet that are currently viewed. After that, the system controller 11 decides whether or not the user adds more rating information to the contents on the Internet that are currently viewed (Step S50). Note that it is decided that the user adds more rating information to the contents on the Internet that are currently viewed, or that the user does not add more rating information to the contents on the Internet that are currently viewed, when the user performs a key operation on the main body operating portion 14 or the remote control transmitter (not shown).

In the decision of Step S50, if it is decided that the user adds more rating information to the contents on the Internet that are currently viewed (YES in Step S50), the process flow goes promptly to Step S90 of the flowchart illustrated in FIG. 3 without performing the decision process of Step S60 described later.

In the decision of Step S50, if it is decided that the user does not add more rating information to the contents on the Internet that are currently viewed (NO in Step S50), the display device of the image output portion 9 displays a screen for inquiring whether or not to perform the view restriction based on the rating information. After that, the system controller 11 decides whether or not to perform the view restriction based on the rating information (Step S60). Note that it is decided to perform the view restriction based on the rating information or not to perform the view restriction based on the rating information, when the user performs a key operation on the main body operating portion 14 or the remote control transmitter (not shown).

In the decision of Step S60, if it is decided to perform the view restriction based on the rating information (YES in Step S60), the system controller 11 sets the view restriction based on the rating information to be valid (Step S70), and the flow action is finished. On the other hand, in the decision of Step S60, if it is decided not to perform the view restriction based on the rating information (NO in Step S60), the system controller 11 sets the view restriction based on the rating information to be invalid (Step S80), and the flow action is finished.

In Step S90 of FIG. 3, the display device of the image output portion 9 displays the rating information editing screen. After that, the system controller 11 decides whether or not it has been instructed to add the rating information to the contents on the Internet (Step S90). Note that it is decided that the user adds more rating information to the contents on the Internet or that the user does not add more rating information to the contents on the Internet, based on a result of the decision of Step S50 or a key operation by the user on the main body operating portion 14 or the remote control transmitter (not shown).

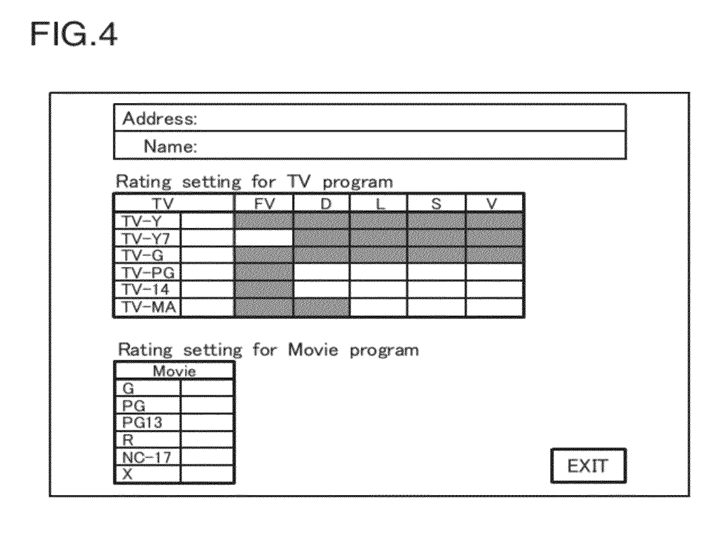

The rating information editing screen in Step S90 is as illustrated in FIG. 4, for example. The rating information editing screen illustrated in FIG. 4 is an example of a case where the network connection is not established or in a case where the process flow goes to Step S90 when viewing no contents on the Internet. In this case, a software key (not shown) displayed on the display screen can be used, for example, to input a delivery source URL address of the contents on the Internet to be a target of editing the rating information.

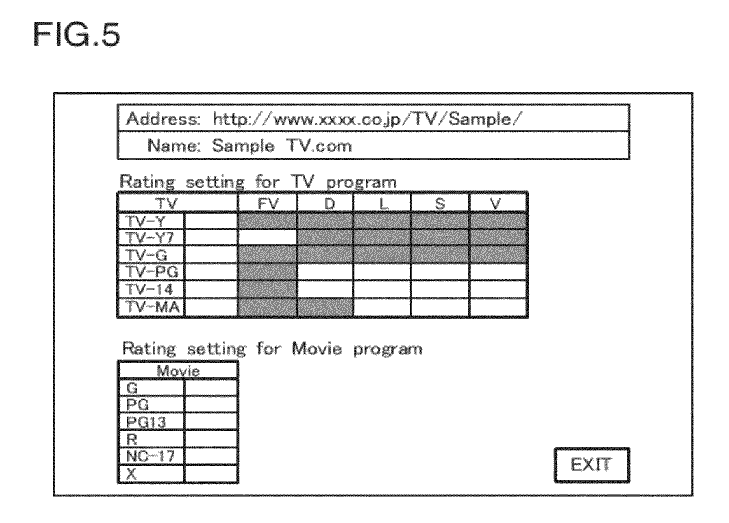

In addition, the rating information editing screen in Step S90 is as illustrated in FIG. 5, for example. The rating information editing screen illustrated in FIG. 5 is an example of a case where the process flow goes to Step S90 when viewing contents on the Internet having no rating information added by the content service provider.

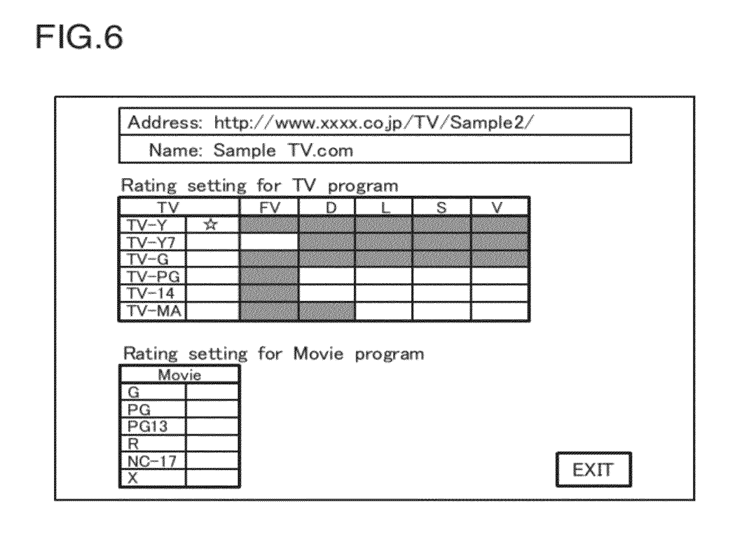

In addition, the rating information editing screen in Step S90 is as illustrated in FIG. 6. The rating information editing screen illustrated in FIG. 6 is an example of a case where the process flow goes to Step S90 when viewing contents on the Internet having rating information added by the content service provider. Note that in the rating information editing screen of this embodiment, the rating information added by the content service provider (“TV-Y” in FIG. 6) is expressed by a white star mark.

When it is instructed to add the rating information to contents on the Internet (YES in Step S90), a genre of the rating information to be added to the contents on the Internet is selected at the same time as the instruction (Step S100). The selection is performed when the user performs a key operation on the main body operating portion 14 or the remote control transmitter (not shown).

If all genres (TV and Movie) are selected (YES in Step S110), the rating information can be edited in all genres (TV and Movie) (Step S130).

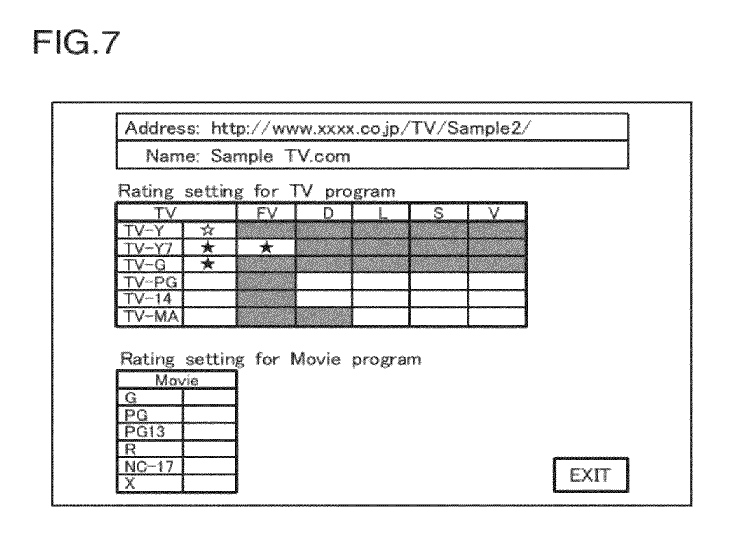

If only the TV genre is selected (NO in Step S110 and YES in Step S120), the rating information can be edited only in the TV genre (Step S140). Here, FIG. 7 illustrates the rating information editing screen in a case where the user adds “TV-Y7, FV” and “TV-G” to the contents of the delivery source URL address “http://www.xxxx.co.jp/TV/Sample/”, in addition to “TV-Y” added by the content service provider, by a key operation on the main body operating portion 14 or the remote control transmitter (not shown). Note that in the rating information editing screen of this embodiment, the rating information added by the user's key operation on the main body operating portion 14 or the remote control transmitter (not shown) (“TV-Y7, FV” and “TV-G” in FIG. 7) is expressed by a black star mark.

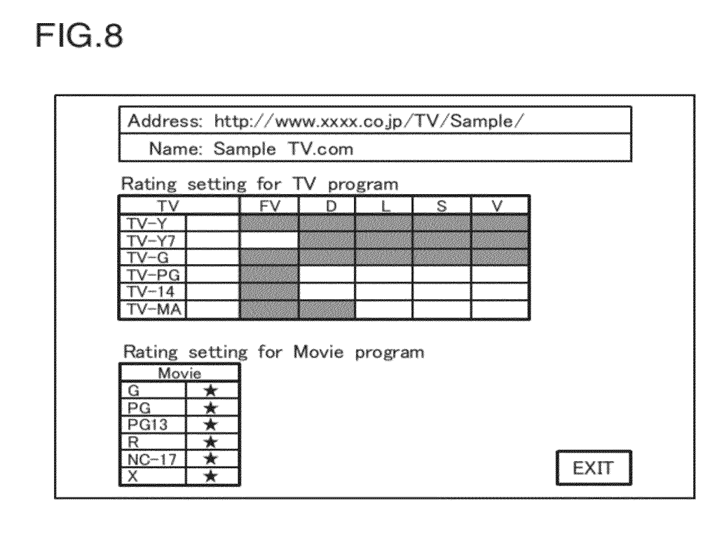

If only the Movie genre is selected (NO in Step S110 and NO in Step S120), the rating information can be edited only in the Movie genre (Step S150). Here, FIG. 8 illustrates the rating information editing screen in a case where the user adds “G”, “PG”, “PG13”, “R”, “NC-17”, and “X” to the contents of the delivery source URL address “http://www.xxxx.co.jp/TV/Sample2/”, by a key operation on the main body operating portion 14 or the remote control transmitter (not shown).

In any one state of Steps S130 to S150, when “EXIT” in the rating information editing screen is selected by the user's key operation on the main body operating portion 14 or the remote control transmitter (not shown), the display device of the image output portion 9 displays a screen for inquiring whether or not to perform the view restriction based on the rating information. After that, the system controller 11 decides whether or not to perform the view restriction based on the rating information (Step S160). Note that it is decided to perform the view restriction based on the rating information or not to perform the view restriction based on the rating information when the user performs a key operation on the main body operating portion 14 or the remote control transmitter (not shown).

In the decision of Step S160, if it is decided to perform the view restriction based on the rating information (YES in Step S160), the system controller 11 sets the view restriction based on the rating information to be valid (Step S170), and the flow action is finished. On the other hand, in the decision of Step S160, if it is decided not to perform the view restriction based on the rating information (NO in Step S160), the system controller 11 sets the view restriction based on the rating information to be invalid (Step S180), and the flow action is finished.

In addition, in the decision of Step S90, if it is decided that it is not instructed to add the rating information to the contents on the Internet (NO in Step S90), the system controller 11 decides whether or not it is instructed to delete the rating information that has been added before to the contents on the Internet (Step S190). Note that it is decided that the user deletes the rating information that has been added before to the contents on the Internet or that the user does not delete the rating information that has been added before to the contents on the Internet, when the user performs a key operation on the main body operating portion 14 or the remote control transmitter (not shown).

In the decision of Step S190, if it is decided that it is not instructed to delete the rating information that has been added before to the contents on the Internet (NO in Step S190), the flow action is finished.

In the decision of Step S190, if it is decided that it is instructed to delete the rating information that has been added before to the contents on the Internet (YES in Step S190), the following process is performed. If the rating information to be deleted is one added by the content service provider (i.e., the rating information expressed by the white star mark) (YES in Step S200), the flow action is finished without performing the deletion. If the rating information to be deleted is one added by the user (i.e., the rating information expressed by the black star mark) (NO in Step S200), the flow action is finished after performing the deletion (Step S210).

By the above-mentioned action, the view restriction of contents on the Internet can be performed.

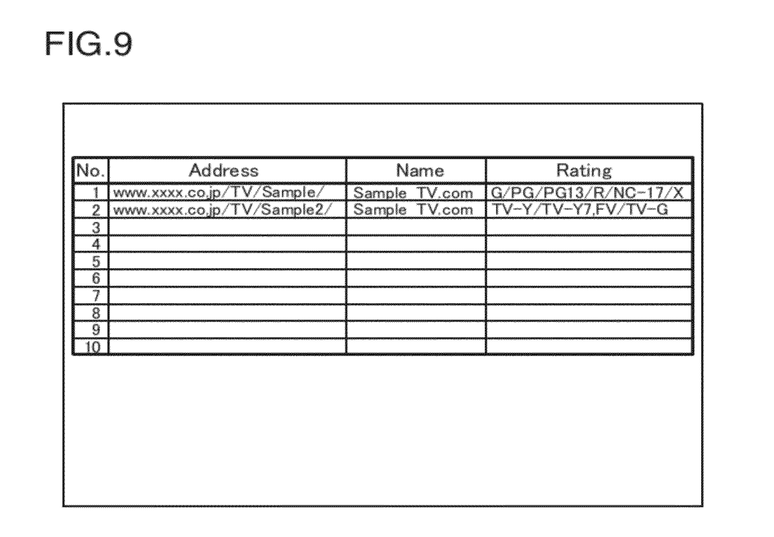

In addition, it is preferable that the display device of the image output portion 9 can display a listing display screen as illustrated in FIG. 9 by a user's key operation on the main body operating portion 14 or the remote control transmitter (not shown), so that the user can easily check a list of the rating information about contents on the Internet.

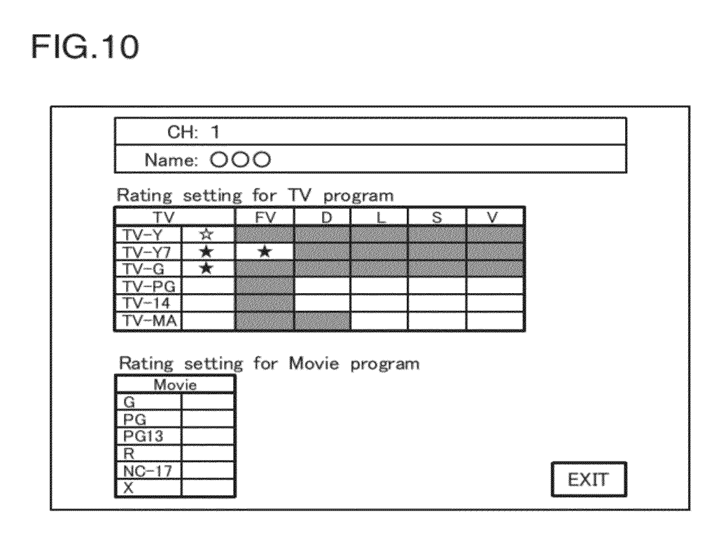

In addition, it is preferable to make a common display form between the rating information editing screen about contents on the Internet and the rating information editing screen about TV broadcasting programs. In the case of the common display form in this way, the rating information editing screen about TV broadcasting programs in this embodiment becomes as illustrated in FIG. 10, for example. In the case of the common display form in this way, when the user master the way of using the rating information editing screen about TV broadcasting programs, the rating information about contents on the Internet editing screen can be also used in the same way. Therefore, the user can easily edit the rating information about contents on the Internet.

In addition, it is assumed that the rating information is once added to the contents on the Internet by the content service provider and is changed later, and that content of the change is notified via a TV broadcasting wave or the Internet as a service to be provided in the near future. Therefore, in order to support this service, it is desirable that the digital tuner 2 or the network connection portion 16 receives a notification of change of the rating information added to the contents on the Internet by the content service provider, and then the system controller 11 rewrites the rating information stored in the memory 12 based on the content of the notification of change.

Although the embodiment of the present invention is described above, the scope of the present invention is not limited to this embodiment, which can be modified variously within the scope of the present invention without deviating from the spirit thereof. For instance, in the embodiment described above, the digital television receiver is exemplified, but the present invention can be applied also to an analog television receiver as long as it has the Internet connection function and the parental control function. In addition, the present invention can be applied not only to the television receiver but also to any electronic equipment having the Internet connection function and the parental control function.

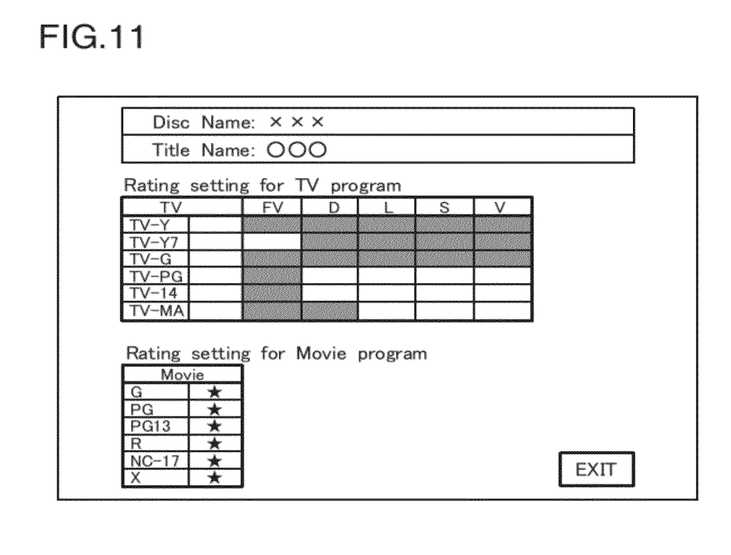

For instance, when the present invention is applied to an optical disc apparatus, it is desirable to make a common display form between the rating information about contents on the Internet editing screen and the rating information editing screen about movies. In the case where the common display form is used in this way, if the rating information about contents on the Internet editing screen has the display form as the above-mentioned embodiment, the rating information editing screen about movies is as illustrated in FIG. 11, for example.

What is claimed is:

1. An electronic equipment having Internet connection function and parental control function, the equipment comprising:
a storage portion that stores rating information about contents on the Internet; and
a viewing restricting portion that performs view restriction of the contents on the Internet based on the rating information about contents on the Internet stored in the storage portion.

2. The electronic equipment according to claim 1, wherein a rating form of the rating information about contents on the Internet is common to a rating form of at least one of rating information for parental control of TV broadcasting programs and rating information for parental control of movies.

3. The electronic equipment according to claim 2, wherein
a display form of an editing screen for editing the rating information about contents on the Internet is common to a display form of an editing screen for editing at least one of rating information about TV broadcasting programs and rating information about movies, and
the electronic equipment further includes an image signal generating portion that generates an image signal for the editing screen.

4. The electronic equipment according to claim 1, wherein the rating information about contents on the Internet stored in the storage portion can be added or deleted.

5. The electronic equipment according to claim 2, wherein the rating information about contents on the Internet stored in the storage portion can be added or deleted.

6. The electronic equipment according to claim 3, wherein the rating information about contents on the Internet stored in the storage portion can be added or deleted.

7. The electronic equipment according to claim 4, wherein if the rating information about contents on the Internet stored in the storage portion is rating information added to the contents on the Internet by a content service provider, the rating information cannot be deleted.

8. The electronic equipment according to claim 5, wherein if the rating information about contents on the Internet stored in the storage portion is rating information added to the contents on the Internet by a content service provider, the rating information cannot be deleted.

9. The electronic equipment according to claim 6, wherein if the rating information about contents on the Internet stored in the storage portion is rating information added to the contents on the Internet by a content service provider, the rating information cannot be deleted.

10. The electronic equipment according to claim 7, further comprising a reception portion that receives a notification of change of the rating information added to the contents on the Internet by the content service provider, wherein the rating information about contents on the Internet stored in the storage portion is rewritten based on content of the notification of change.

11. The electronic equipment according to claim 8, further comprising a reception portion that receives a notification of change of the rating information added to the contents on the Internet by the content service provider, wherein the rating information about contents on the Internet stored in the storage portion is rewritten based on content of the notification of change.

12. The electronic equipment according to claim 9, further comprising a reception portion that receives a notification of change of the rating information added to the contents on the Internet by the content service provider, wherein the rating information about contents on the Internet stored in the storage portion is rewritten based on content of the notification of change.
